(19) United States
(12) Patent Application Publication
(10) Pub. No.: US 2026/0311583 A1
(43) Pub. Date: Oct. 8, 2026

(54) AUTOMATED WARNING SAFETY GUARDS FOR WAREHOUSE DRONES

(71) Applicant: Brookhurst Garage, Inc., San Jose, CA (US)

(72) Inventor: Young Joon Kim, San Jose, CA (US)

(21) Appl. No.: 19/171,872

(22) Filed: Apr. 7, 2025

(51) Int. Cl. G08B 21/02; G05D 1/622; G05D 1/689; G05D 105/80; G05D 107/70; G05D 109/20; G05D 111/10; G05D 111/30; G08B 7/06

(52) U.S. Cl. CPC G08B 21/02; G05D 1/622; G05D 1/689; G08B 7/06; G05D 2105/93; G05D 2107/70; G05D 2109/20; G05D 2111/10; G05D 2111/32

(57) ABSTRACT

A safety alert device that issues an indication when an aerial drone is detected at a particular location of a storage site. The aerial drone autonomously navigates in the storage site to perform inventory management tasks. The safety alert device installed at an entrance of an aisle of the storage site issues a safety indication signifying that the aerial drone is located in the aisle. The safety alert device includes alert indication hardware components such as a buzzer to provide auditory signals and a lamp to provide visual signals. The aerial drone can adjust navigational path according to data indicating a detection of a particular aisle in use.

### FIELD OF THE INVENTION

This disclosure relates to devices used in a storage site and, more specifically to safety alert devices that indicate various signals throughout the storage site.

### BACKGROUND

In an inventory management environment, the use of aerial drones for performing inventory tasks can pose complex situations. There are times when the individuals in the storage site are unaware of the aerial drone's location, leading to potential accidents or injuries.

### SUMMARY

Embodiments relate to a safety alert device that includes a visual and auditory signal component for issuing safety indication. The safety alert device is designed to enhance safety in environments such as inventory warehouses, where aerial drones are used for tasks like inventory management. The safety alert device can be triggered by various factors, including aerial drone navigation, environmental conditions, or specific issues detected within the inventory warehouse, ensuring a responsive safety mechanism.

### BRIEF DESCRIPTION OF THE DRAWINGS

FIG. 1 is a block diagram that illustrates a system environment of an example storage site, in accordance with one or more embodiments.

FIG. 2 is a block diagram that illustrates components of an example robot and an example base station, in accordance one or more embodiments.

FIG. 3 is a flowchart that depicts an example process for managing the inventory of a storage site, in accordance with one or more embodiments.

FIG. 4 is a conceptual diagram of an example layout of a storage site that is equipped with a robot, in accordance with one or more embodiments.

FIG. 5A is a conceptual diagram of an example layout of an inventory warehouse that is equipped with an aerial drone and shelving racks, in accordance with one or more embodiments.

FIG. 5B is a conceptual diagram of an example layout of one or more zones in an inventory warehouse that is equipped with an aerial drone and shelving racks, in accordance with one or more embodiments.

FIG. 6 is a block diagram illustrating components of an example safety alert communication system for an aerial drone, in accordance with one or more embodiments.

FIG. 7 is an isolated view of a safety alert device, in accordance with one or more embodiments.

FIGS. 8A, 8B, and 8C illustrate different angle views of a safety alert device attached to a pilar, in accordance with one or more embodiments.

FIG. 9 is a flowchart for a method for inventory management in an inventory warehouse, in accordance with one or more embodiments.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

FIG. (Figure) 1 is a block diagram that illustrates a system environment 100 of an example robotically-assisted or fully autonomous storage site, according to an embodiment. By way of example, the system environment 100 includes a storage site 110, a robot 120, a base station 130, an inventory management system 140, a computing server 150, a data store 160, and a user device 170. The entities and components in the system environment 100 communicate with each other through the network 180. In various embodiments, the system environment 100 may include different, fewer, or additional components. Also, while each of the components in the system environment 100 is described in a singular form, the system environment 100 may include one or more of each of the components. For example, the storage site 110 may include one or more robots 120 and one or more base stations 130. Each robot 120 may have a corresponding base station 130 or multiple robots 120 may share a base station 130.

A storage site 110 may be any suitable facility that stores, sells, or displays inventories such as goods, merchandise, groceries, articles and collections. Example storage sites 110 may include warehouses, inventory sites, bookstores, shoe stores, outlets, other retail stores, libraries, museums, etc. A storage site 110 may include a number of regularly shaped structures. Regularly shaped structures may be structures, fixtures, equipment, furniture, frames, shells, racks, or other suitable things in the storage site 110 that have a regular shape or outline that can be readily identifiable, whether the things are permanent or temporary, fixed or movable, weight-bearing or not. The regularly shaped structures are often used in a storage site 110 for storage of inventory. For example, racks (including metallic racks, shells, frames, or other similar structures) are often used in a warehouse for the storage of goods and merchandise. However, not all regularly shaped structures may need to be used for inventory storage. A storage site 110 may include a certain layout that allows various items to be placed and stored systematically. For example, in a warehouse, the racks may be grouped by sections and separated by aisles. Each rack may include multiple pallet locations that can be identified using a row number and a column number. A storage site may include high racks and low racks, which may, in some case, largely carry most of the inventory items near the ground level.

A storage site 110 may include one or more robots 120 that are used to keep track of the inventory and to manage the inventory in the storage site 110. For the ease of reference, the robot 120 may be referred to in a singular form, even though more than one robot 120 may be used. Also, in some embodiments, there can be more than one type of robot 120 in a storage site 110. For example, some robots 120 may specialize in scanning inventory in the storage site 110, while other robots 120 may specialize in moving items. A robot 120 may also be referred to as an autonomous robot, an inventory cycle-counting robot, an inventory survey robot, an inventory detection robot, or an inventory management robot. An inventory robot may be used to track inventory items, move inventory items, and carry out other inventory management tasks. The degree of autonomy may vary from embodiments to embodiments. For example, in one embodiment, the robot 120 may be fully autonomous so that the robot 120 automatically performs assigned tasks. In another embodiment, the robot 120 may be semi-autonomous such that it can navigate through the storage site 110 with minimal human commands or controls. In some embodiments, no matter what the degree of autonomy it has, a robot 120 may also be controlled remotely and may be switched to a manual mode. The robot 120 may take various forms such as an aerial drone, a ground robot, a vehicle, a forklift, and a mobile picking robot.

A base station 130 may be a device for the robot 120 to return and, for an aerial robot, to land. The base station 130 may include more than one return site. The base station 130 may be used to repower the robot 120. Various ways to repower the robot 120 may be used in different embodiments. For example, in one embodiment, the base station 130 serves as a battery-swapping station that exchanges batteries on a robot 120 as the robot arrives at the base station to allow the robot 120 to quickly resume duty. The replaced batteries may be charged at the base station 130, wired or wirelessly. In another embodiment, the base station 130 serves as a charging station that has one or more charging terminals to be coupled to the charging terminal of the robot 120 to recharge the batteries of the robot 120. In yet another embodiment, the robot 120 may use fuel for power and the base station 130 may repower the robot 120 by filling its fuel tank.

The base station 130 may also serve as a communication station for the robot 120. For example, for certain types of storage sites 110 such as warehouses, network coverage may not be present or may only be present at certain locations. The base station 130 may communicate with other components in the system environment 100 using wireless or wired communication channels such as Wi-Fi or an Ethernet cable. The robot 120 may communicate with the base station 130 when the robot 120 returns to the base station 130. The base station 130 may send inputs such as commands to the robot 120 and download data captured by the robot 120. In embodiments where multiple robots 120 are used, the base station 130 may be equipped with a swarm control unit or algorithm to coordinate the movements among the robots. The base station 130 and the robot 120 may communicate in any suitable ways such as radio frequency, Bluetooth, near-field communication (NFC), or wired communication. While, in one embodiment, the robot 120 mainly communicates to the base station, in other embodiments the robot 120 may also have the capability to directly communicate with other components in the system environment 100. In one embodiment, the base station 130 may serve as a wireless signal amplifier for the robot 120 to directly communicate with the network 180.

The inventory management system 140 may be a computing system that is operated by the administrator (e.g., a company that owns the inventory, a warehouse management administrator, a retailer selling the inventory) using the storage site 110. The inventory management system 140 may be a system used to manage the inventory items. The inventory management system 140 may include a database that stores data regarding inventory items and the items'associated information, such as quantities in the storage site 110, metadata tags, asset type tags, barcode labels and location coordinates of the items. The inventory management system 140 may provide both front-end and back-end software for the administrator to access a central database and point of reference for the inventory and to analyze data, generate reports, forecast future demands, and manage the locations of the inventory items to ensure items are correctly placed. An administrator may rely on the item coordinate data in the inventory management system 140 to ensure that items are correctly placed in the storage site 110 so that the items can be readily retrieved from a storage location. This prevents an incorrectly placed item from occupying a space that is reserved for an incoming item and also reduces time to locate a missing item at an outbound process.

The computing server 150 may be a server that is tasked with analyzing data provided by the robot 120 and provide commands for the robot 120 to perform various inventory recognition and management tasks. The robot 120 may be controlled by the computing server 150, the user device 170, or the inventory management system 140. For example, the computing server 150 may direct the robot 120 to scan and capture pictures of inventory stored at various locations at the storage site 110. Based on the data provided by the inventory management system 140 and the ground truth data captured by the robot 120, the computing server 150 may identify discrepancies in two sets of data and determine whether any items may be misplaced, lost, damaged, or otherwise should be flagged for various reasons. In turn, the computing server 150 may direct a robot 120 to remedy any potential issues such as moving a misplaced item to the correct position. In one embodiment, the computing server 150 may also generate a report of flagged items to allow site personnel to manually correct the issues.

The computing server 150 may include one or more computing devices that operate at different locations. For example, a part of the computing server 150 may be a local server that is located at the storage site 110. The computing hardware such as the processor may be associated with a computer on site or may be included in the base station 130. Another part of the computing server 150 may be a cloud server that is geographically distributed. The computing server 150 may serve as a ground control station (GCS), provide data processing, and maintain end-user software that may be used in a user device 170. A GCS may be responsible for the control, monitor and maintenance of the robot 120. In one embodiment, GCS is located on-site as part of the base station 130. The data processing pipeline and end-user software server may be located remotely or on-site.

The computing server 150 may maintain software applications for users to manage the inventory, the base station 130, and the robot 120. The computing server 150 and the inventory management system 140 may or may not be operated by the same entity. In one embodiment, the computing server 150 may be operated by an entity separated from the administrator of the storage site. For example, the computing server 150 may be operated by a robotic service provider that supplies the robot 120 and related systems to modernize and automate a storage site 110. The software application provided by the computing server 150 may take several forms. In one embodiment, the software application may be integrated with or as an add-on to the inventory management system 140. In another embodiment, the software application may be a separate application that supplements or replaces the inventory management system 140. In one embodiment, the software application may be provided as software as a service (SaaS) to the administrator of the storage site 110 by the robotic service provider that supplies the robot 120.

The data store 160 includes one or more storage units such as memory that takes the form of non-transitory and non-volatile computer storage medium to store various data that may be uploaded by the robot 120 and inventory management system 140. For example, the data stored in data store 160 may include pictures, sensor data, and other data captured by the robot 120. The data may also include inventory data that is maintained by the inventory management system 140. The computer-readable storage medium is a medium that does not include a transitory medium such as a propagating signal or a carrier wave. The data store 160 may take various forms. In one embodiment, the data store 160 communicates with other components by the network 180. This type of data store 160 may be referred to as a cloud storage server. Example cloud storage service providers may include AWS, AZURE STORAGE, GOOGLE CLOUD STORAGE, etc. In another embodiment, instead of a cloud storage server, the data store 160 is a storage device that is controlled and connected to the computing server 150. For example, the data store 160 may take the form of memory (e.g., hard drives, flash memories, discs, ROMs, etc.) used by the computing server 150 such as storage devices in a storage server room that is operated by the computing server 150.

The user device 170 may be used by an administrator of the storage site 110 to provide commands to the robot 120 and to manage the inventory in the storage site 110. For example, using the user device 170, the administrator can provide task commands to the robot 120 for the robot to automatically complete the tasks. In one case, the administrator can specify a specific target location or a range of storage locations for the robot 120 to scan. The administrator may also specify a specific item for the robot 120 to locate or to confirm placement. Examples of user devices 170 include personal computers (PCs), desktop computers, laptop computers, tablet computers, smartphones, wearable electronic devices such as smartwatches, or any other suitable electronic devices.

The user device 170 may include a user interface 175, which may take the form of a graphical user interface (GUI). Software application provided by the computing server 150 or the inventory management system 140 may be displayed as the user interface 175. The user interface 175 may take different forms. In one embodiment, the user interface 175 is part of a front-end software application that includes a GUI displayed at the user device 170. In one case, the front-end software application is a software application that can be downloaded and installed at user devices 170 via, for example, an application store (e.g., App Store) of the user device 170. In another case, the user interface 175 takes the form of a Web interface of the computing server 150 or the inventory management system 140 that allows clients to perform actions through web browsers. In another embodiment, user interface 175 does not include graphical elements but communicates with the computing server 150 or the inventory management system 140 via other suitable ways such as command windows or application program interfaces (APIs).

The communications among the robot 120, the base station 130, the inventory management system 140, the computing server 150, the data store 160, and the user device 170 may be transmitted via a network 180, for example, via the Internet. In one embodiment, the network 180 uses standard communication technologies and/or protocols. Thus, the network 180 can include links using technologies such as Ethernet, 802.11, worldwide interoperability for microwave access (WiMAX), 3G, 4G, LTE, 5G, digital subscriber line (DSL), asynchronous transfer mode (ATM), InfiniBand, PCI Express, etc. Similarly, the networking protocols used on the network 180 can include multiprotocol label switching (MPLS), the transmission control protocol/Internet protocol (TCP/IP), the user datagram protocol (UDP), the hypertext transport protocol (HTTP), the simple mail transfer protocol (SMTP), the file transfer protocol (FTP), etc. The data exchanged over the network 180 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet protocol security (IPsec), etc. The network 180 also includes links and packet switching networks such as the Internet. In some embodiments, two computing servers, such as computing server 150 and inventory management system 140, may communicate through APIs. For example, the computing server 150 may retrieve inventory data from the inventory management system 140 via an API.

### Example Robot and Base Station

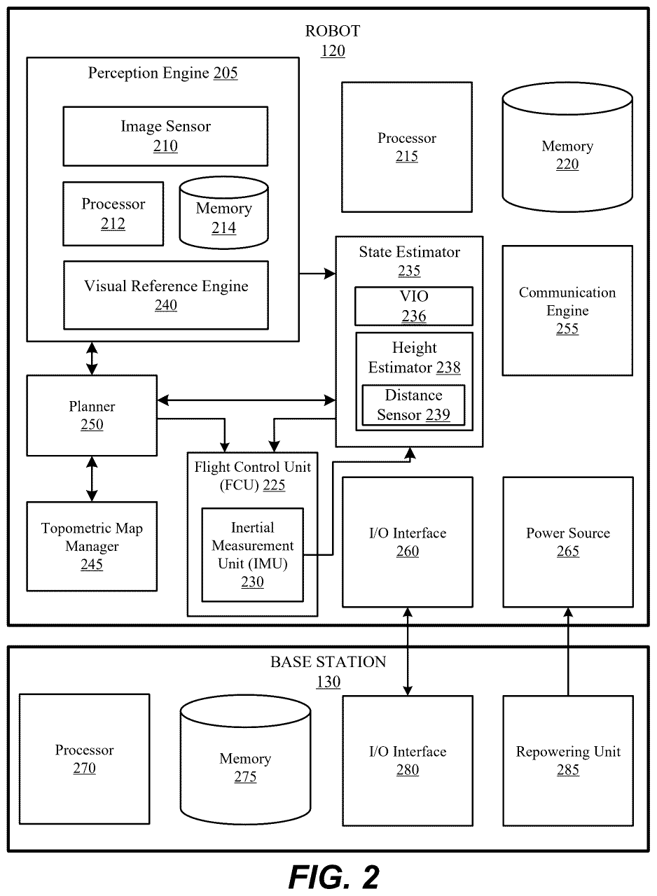

FIG. 2 is a block diagram illustrating components of an example robot 120 and an example base station 130, according to an embodiment. The robot 120 may include a perception engine 205 that includes an image sensor 210 and a visual reference engine 240, a processor 215, memory 220, a flight control unit (FCU) 225 that includes an inertia measurement unit (IMU) 230, a state estimator 235, a topometric map manager 245, a planner 250, a communication engine 255, an I/O interface 260, and a power source 265. The functions of the robot 120 may be distributed among various components in a different manner than described below. In various embodiments, the robot 120 may include different, fewer, and/or additional components. Also, while each of the components in FIG. 2 is described in a singular form, the components may present in plurality. For example, a robot 120 may include more than one image sensor 210 and more than one processor 215.

The perception engine 205 may be a combination of software and hardware, which may include an image sensor 210, its own processor 212, and memory 214 that stores a set of instructions. In various embodiments, the perception engine 205 may include more than one image sensor 210, more than one processor 212 and more than one memory 214. The image sensor 210 may be configured to capture images of an environment of a storage site for navigation, localization, collision avoidance, object recognition and identification, and inventory recognition purposes. The perception engine may include more than one image sensors 210 and more than one type of such image sensors 210. For example, the perception engine 205 may include a digital camera that captures optical images of the environment for the state estimator 235. For example, data captured by the image sensor 210 may also be provided to the VIO unit 236 that may be included in the state estimator 235 for localization purposes such as to determine the position and orientation of the robot 120 with respect to an inertial frame, such as a global frame whose location is known and fixed. The perception engine 205 may also include a stereo camera that includes two or more lenses to allow the image sensor 210 to capture three-dimensional images through stereoscopic photography. For each image frame, the stereo camera may generate pixel values such as in red, green, and blue (RGB) and point cloud data that includes depth information. The images captured by the stereo camera may be provided to visual reference engine 240 for object recognition purposes. The image sensor 210 may also be another type of image sensor such as a light detection and ranging (LIDAR) sensor, an infrared camera, and 360-degree depth cameras. The image sensor 210 may also capture pictures of labels (e.g., barcodes) on items for inventory cycle-counting purposes. In some embodiments, a single stereo camera may be used for various purposes. For example, the stereo camera may provide image data to the visual reference engine 240 for object recognition. The stereo camera may also be used to capture pictures of labels (e.g., barcodes). In some embodiments, the robot 120 includes a rotational mount such as a gimbal that allows the image sensor 210 to rotate in different angles and to stabilize images captured by the image sensor 210. In one embodiment, the image sensor 210 may also capture data along the path for the purpose of mapping the storage site.

The visual reference engine 240 may correspond to a set of software instructions stored in the memory 214 that can be executed by the processor 212. The visual reference engine 240 may include various image processing algorithm and location algorithm to determine the current location of the robot 120, to identify the objects, edges, and surfaces of the environment near the robot 120, and to determine an estimated distance and orientation (e.g., yaw) of the robot 120 relative to a nearby surface of an object. The visual reference engine 240 may receive pixel data of a series of images and point cloud data from the image sensor 210. The location information generated by the visual reference engine 240 may include distance and yaw from an object and center offset from a target point (e.g., a midpoint of a target object).

The visual reference engine 240 may include one or more algorithms and machine learning models to create image segmentations from the images captured by the image sensor 210. The image segmentation may include one or more segments that separate the frames (e.g., vertical or horizontal bars of racks) or outlines of regularly shaped structures appearing in the captured images from other objects and environments. The algorithms used for image segmentation may include a convolutional neural network (CNN). In performing the segmentation, other image segmentation algorithms such as edge detection algorithms (e.g., Canny operator, Laplacian operator, Sobel operator, Prewitt operator), corner detection algorithms, Hough transform, and other suitable feature detection algorithms may also be used.

The visual reference engine 240 also performs object recognition (e.g., object detection and further analyses) and keeps track of the relative movements of the objects across a series of images. The visual reference engine 240 may track the number of regularly shaped structures in the storage site 110 that are passed by the robot 120. For example, the visual reference engine 240 may identify a reference point (e.g., centroid) of a frame of a rack and determine if the reference point passes a certain location of the images across a series of images (e.g., whether the reference point passes the center of the images). If so, the visual reference engine 240 increments the number of regularly shaped structures that have been passed by the robot 120.

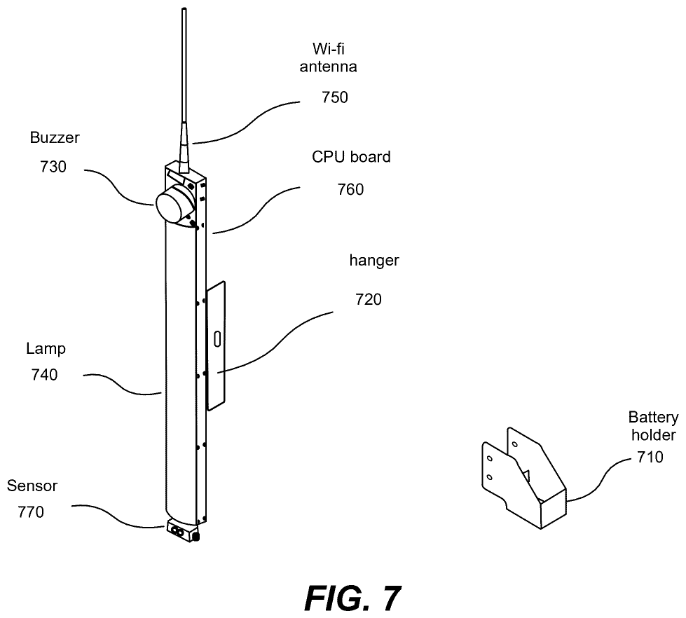

The processor 212 may be configured to execute a set of instructions stored in memory 214. The set of instructions, when executed by the processor 212, may cause the processor 212 to carry out processes that instruct the image sensor 210 to capture images of an environment of a storage site, and instruct the visual reference engine 240 to process the captured image data. The memory 214 may also store images and videos captured by the image sensor 210. The perception engine 205 may communicate with the visual reference engine 240 and the state estimator 235 for purposes of navigation, localization, object recognition, collision avoidance, and identification and inventory recognition. For example, the perception engine 205 may take images to measure structural components of the regularly shaped structures found in the storage site. The perception engine 205 receives instructions from the planner 250 to detect a known structure or structural component, such as a rack, a horizontal beam, or an upright beam of a rack. In response, the processor 212 instructs the image sensor 210 to take images of the target structure or structural component, and the data captured by the image sensor 210 is provided to the visual reference engine 240. The visual reference engine 240 may perform various image processing algorithms to identify the structural component in the environment near the robot 120, The state estimator 235 may determine the position and orientation of the robot 120 with respect to an inertial frame, such as a global frame whose location is known and fixed. The captured data is used to measure the structural component and calculate the relative pose of the robot with respect to the structure. Details of how the perception engine 205 may be used by the robot 120 to navigate the storage facility and manage inventory are discussed in FIG. 7 through FIG. 9.

The robot 120 includes one or more processors 215 and one or more memories 220 that store one or more sets of instructions. The one or more sets of instructions, when executed by one or more processors, cause the one or more processors to carry out processes that are implemented as one or more software engines. Various components, such as FCU 225 and state estimator 235, of the robot 120 may be implemented as a combination of software and hardware (e.g., sensors). The robot 120 may use a single general processor to execute various software engines or may use separate more specialized processors for different functionalities. In one embodiment, the robot 120 may use a general-purpose computer (e.g., a CPU) that can execute various instruction sets for various components (e.g., FCU 225, visual reference engine 240, state estimator 235, planner 250). The general-purpose computer may run on a suitable operating system such as LINUX, ANDROID, etc. For example, in one embodiment, the robot 120 may carry a smartphone that includes an application used to control the robot. In another embodiment, the robot 120 includes multiple processors that are specialized in different functionalities. For example, some of the functional components such as FCU 225, state estimator 235, and planner 250 may be modularized and each includes its own processor, memory, and a set of instructions. The robot 120 may include a central processor unit (CPU) to coordinate and communicate with each modularized component. Hence, depending on embodiments, a robot 120 may include a single processor or multiple processors 215 to carry out various operations. The memory 220 may also store images and videos captured by the image sensor 210 from the perception engine 205. The images may include images that capture the surrounding environment and images of the inventory such as barcodes and labels.

The flight control unit (FCU) 225 may be a combination of software and hardware, such as inertial measurement unit (IMU) 230 and other sensors, to control the movement of the robot 120. For ground robot 120, the flight control unit 225 may also be referred to as a microcontroller unit (MCU). The FCU 225 relies on information provided by other components to control the movement of the robot 120. For example, the planner 250 determines the path of the robot 120 from a starting point to a destination and provides commands to the FCU 225. Based on the commands, the FCU 225 generates electrical signals to various mechanical parts (e.g., actuators, motors, engines, wheels) of the robot 120 to adjust the movement of the robot 120. The precise mechanical parts of the robots 120 may depend on the embodiments and the types of robots 120.

The IMU 230 may be part of the FCU 225 or may be an independent component. The IMU 230 may include one or more accelerometers, gyroscopes, and other suitable sensors to generate measurements of forces, linear accelerations, and rotations of the robot 120. For example, the accelerometers measure the force exerted on the robot 120 and detect the linear acceleration. Multiple accelerometers cooperate to detect the acceleration of the robot 120 in the three-dimensional space. For instance, a first accelerometer detects the acceleration in the x-direction, a second accelerometer detects the acceleration in the y-direction, and a third accelerometer detects the acceleration in the z-direction. The gyroscopes detect the rotations and angular velocity of the robot 120. Based on the measurements, a processor 215 may obtain the estimated localization of the robot 120 by integrating the translation and rotation data of the IMU 230 with respect to time. The IMU 230 may also measure the orientation of the robot 120. For example, the gyroscopes in the IMU 230 may provide readings of the pitch angle, the roll angle, and the yaw angle of the robot 120.

The state estimator 235 may correspond to a set of software instructions stored in the memory 220 that can be executed by the processor 215. The state estimator 235 may be used to generate localization information of the robot 120 and may include various sub-components for estimating the state of the robot 120. For example, in one embodiment, the state estimator 235 may include a visual-inertial odometry (VIO) unit 236 and a height estimator 238. In other embodiments, other modules, sensors, and algorithms may also be used in the state estimator 235 to determine the location of the robot 120.

The VIO unit 236 receives image data from the image sensor 210 (e.g., a stereo camera) and measurements from IMU 230 to generate localization information such as the position and orientation of the robot 120. The localization data obtained from the double integration of the acceleration measurements from the IMU 230 is often prone to drift errors. The VIO unit 236 may extract image feature points and tracks the feature points in the image sequence to generate optical flow vectors that represent the movement of edges, boundaries, surfaces of objects in the environment captured by the image sensor 210. Various signal processing techniques such as filtering (e.g., Wiener filter, Kalman filter, bandpass filter, particle filter) and optimization, and data/image transformation may be used to reduce various errors in determining localization information. The localization data generated by the VIO unit 236 may include an estimate of the pose of the robot 120, which may be expressed in terms of the 3D position (x, y, z), the roll angle, the pitch angle, and the yaw angle of the robot 120.

The height estimator 238 may be a combination of software and hardware that are used to determine the absolute height and relative height (e.g., distance from an object that lies on the floor) of the robot 120. The height estimator 238 may include a downward distance sensor 239 that may measure the height relative to the ground or to an object underneath the robot 120. The distance sensor 239 may be electromagnetic wave based, laser based, optics based, sonar based, ultrasonic based, or another suitable signal based. For example, the distance sensor 239 may be a laser range finder, a lidar range finder, a sonar range finder, an ultrasonic range finder, or a radar. A range finder may include one or more emitters that emit signals (e.g., infrared, laser, sonar, etc.) and one or more sensors that detect the round trip time of the signal reflected by an object. In some embodiments, the robot 120 may be equipped with a single emitter range finder. The height estimator 238 may also receive data from the VIO unit 236 that may estimate the height of the robot 120, but usually in a less accurate fashion compared to a distance sensor 239. The height estimator 238 may include software algorithms to combine data generated by the distance sensor 239 and the data generated by the VIO unit 236 as the robot 120 flies over various objects and inventory that are placed on the floor or other horizontal levels. The data generated by the height estimator 238 may be used for collision avoidance and finding a target location. The height estimator 238 may set a global maximum altitude to prevent the robot 120 from hitting the ceiling. The height estimator 238 also provides information regarding how many rows in the rack are below the robot 120 for the robot 120 to locate a target location. The height data may be used in conjunction with the count of rows that the robot 120 has passed to determine the vertical level of the robot 120.

The robot 120 may use various components to generate various types of location information (including location information relative to nearby objects and localization information). For example, in one embodiment, the state estimator 235 may process the data from the VIO unit 236 and the height estimator 238 to provide localization information to the planner 250. The visual reference engine 240 may count the number of regularly shaped structures that the robot 120 has passed to determine a current location. The visual reference engine 240 may generate location information relative to nearby objects. For example, when the robot 120 reaches a target location of a rack, the visual reference engine 240 may use point cloud data to reconstruct a surface of the rack and use the depth data from the point cloud to determine more accurate yaw and distance between the robot 120 and the rack. The visual reference engine 240 may determine a center offset, which may correspond to the distance between the robot 120 and the center of a target location (e.g., the midpoint of a target location of a rack). Using the center offset information, the planner 250 controls the robot 120 to move to the target location and take a picture of the inventory in the target location. When the robot 120 changes direction (e.g., rotations, transitions from horizontal movement to vertical movement, transitions from vertical movement to horizontal movement, etc.), the center offset information may be used to determine the accurate location of the robot 120 relative to an object.

The topometric map manager 245 may correspond to a set of software instructions stored in the memory 220 that can be executed by the processor 215. The topometric map manager 245 may include algorithm that generate and manage one or more topometric maps stored in the memory 220. A topometric map may correspond to the topology of the storage site 110 and may include metrics that measure precise dimensions of different components in the topology. The topometric map manager 245 may download an initial version of the topometric map that is provided by computing server 150 and direct the robot 120 to survey the storage site 110 to measure or verify the metric values at various locations of the storage site 110.

The planner 250 may correspond to a set of software instructions stored in the memory 220 that can be executed by the processor 215. The planner 250 may request the Topometric Map Manager 245 which includes various routing algorithms to plan a path of the robot 120 as the robot travels from a first location (e.g., a starting location, the current location of the robot 120 after finishing the previous journey) to a second location (e.g., a target destination). The robot 120 may receive inputs such as user commands to perform certain actions (e.g., scanning of inventory, moving an item, etc.) at certain locations. The planner 250 may include two types of routes, which corresponds to a spot check and a range scan. In a spot check, the planner 250 may receive an input that includes coordinates of one or more specific target locations. In response, the planner 250 plans a path for the robot 120 to travel to the target locations to perform an action. In a range scan, the input may include a range of coordinates corresponding to a range of target locations. In response, the planner 250 plans a path for the robot 120 to perform a full scan or actions for the range of target locations. Whether the robot 120 is performing a spot check or a range scan, the planner 250 may use a topometric map to determine the path to complete the action.

The planner 250 may plan the route of the robot 120 based on data provided by the visual reference engine 240 and the data provided by the state estimator 235. For example, the visual reference engine 240 estimates the current location of the robot 120 by tracking the number of regularly shaped structures in the storage site 110 passed by the robot 120. Based on the location information provided by the visual reference engine 240, the planner 250 determines the route of the robot 120 and may adjust the movement of the robot 120 as the robot 120 travels along the route.

The planner 250 may also include a fail-safe mechanism in the case where the movement of the robot 120 has deviated from the plan. For example, if the planner 250 determines that the robot 120 has passed a target aisle and traveled too far away from the target aisle, the planner 250 may send signals to the FCU 225 to try to remedy the path. If the error is not remedied after a timeout or within a reasonable distance, or the planner 250 is unable to correctly determine the current location, the planner 250 may direct the FCU to land or to stop the robot 120.

Relying on various location information, the planner 250 may also include algorithms for collision avoidance purposes. In one embodiment, the planner 250 relies on the distance information, the yaw angle, and center offset information relative to nearby objects to plan the movement of the robot 120 to provide sufficient clearance between the robot 120 and nearby objects. Alternatively, or additionally, the robot 120 may include one or more depth cameras such as a 360-degree depth camera set that generates distance data between the robot 120 and nearby objects. The planner 250 uses the location information from the depth cameras to perform collision avoidance.

The communication engine 255 and the I/O interface 260 are communication components to allow the robot 120 to communicate with other components in the system environment 100. A robot 120 may use different communication protocols, wireless or wired, to communicate with an external component such as the base station 130. Example communication protocols may include Wi-Fi, Bluetooth, NFC, USB, etc. that couple the robot 120 to the base station 130. The robot 120 may transmit various types of data, such as image data, flight logs, location data, inventory data, and robot status information. The robot 120 may also receive inputs from an external source to specify the actions that need to be performed by the robot 120. The commands may be automatically generated or manually generated by an administrator. The communication engine 255 may include algorithms for various communication protocols and standards, encoding, decoding, multiplexing, traffic control, data encryption, etc. for various communication processes. The I/O interface 260 may include software and hardware component such as hardware interface, antenna, and so forth for communication.

The robot 120 also includes a power source 265 used to power various components and the movement of the robot 120. The power source 265 may be one or more batteries or a fuel tank. Example batteries may include lithium-ion batteries, lithium polymer (LiPo) batteries, fuel cells, and other suitable battery types. The batteries may be placed inside permanently or may be easily replaced. For example, batteries may be detachable so that the batteries may be swapped when the robot 120 returns to the base station 130.

While FIG. 2 illustrates various example components, a robot 120 may include additional components. For example, some mechanical features and components of the robot 120 are not shown in FIG. 2. Depending on its type, the robot 120 may include various types of motors, actuators, robotic arms, lifts, other movable components, other sensors for performing various tasks.

Continuing to refer to FIG. 2, an example base station 130 includes a processor 270, a memory 275, an I/O interface 280, and a repowering unit 285. In various embodiments, the base station 130 may include different, fewer, and/or additional components.

The base station 130 includes one or more processors 270 and one or more memories 275 that include one or more set of instructions for causing the processors 270 to carry out various processes that are implemented as one or more software modules. The base station 130 may provide inputs and commands to the robot 120 for performing various inventory management tasks. The base station 130 may also include an instruction set for performing swarm control among multiple robots 120. Swarm control may include task allocation, routing and planning, coordination of movements among the robots to avoid collisions, etc. The base station 130 may serve as a central control unit to coordinate the robots 120. The memory 275 may also include various sets of instructions for performing analysis of data and images downloaded from a robot 120. The base station 130 may provide various degrees of data processing from raw data format conversion to a full data processing that generates useful information for inventory management. Alternatively, or additionally, the base station 130 may directly upload the data downloaded from the robot 120 to a data store, such as the data store 160. The base station 130 may also provide operation, administration, and management commands to the robot 120. In one embodiment, the base station 130 can be controlled remotely by the user device 170, the computing server 150, or the inventory management system 140.

The base station 130 may also include various types of I/O interfaces 280 for communications with the robot 120 and to the Internet. The base station 130 may communicate with the robot 120 continuously using a wireless protocol such as Wi-Fi or Bluetooth. In one embodiment, one or more components of the robot 120 in FIG. 2 may be located in the base station and the base station may provide commands to the robot 120 for movement and navigation. Alternatively, or additionally, the base station 130 may also communicate with the robot 120 via short-range communication protocols such as NFC or wired connections when the robot 120 lands or stops at the base station 130. The base station 130 may be connected to the network 180 such as the Internet. The wireless network (e.g., LAN) in some storage sites 110 may not have sufficient coverage. The base station 130 may be connected to the network 180 via an Ethernet cable.

The repowering unit 285 includes components that are used to detect the power level of the robot 120 and to repower the robot 120. Repowering may be done by swapping the batteries, recharging the batteries, re-filling the fuel tank, etc. In one embodiment, the base station 130 includes mechanical actuators such as robotic arms to swap the batteries on the robot 120. In another embodiment, the base station 130 may serve as the charging station for the robot 120 through wired charging or inductive charging. For example, the base station 130 may include a landing or resting pad that has an inductive coil underneath for wirelessly charging the robot 120 through the inductive coil in the robot. Other suitable ways to repower the robot 120 is also possible.

### Example Inventory Management Process

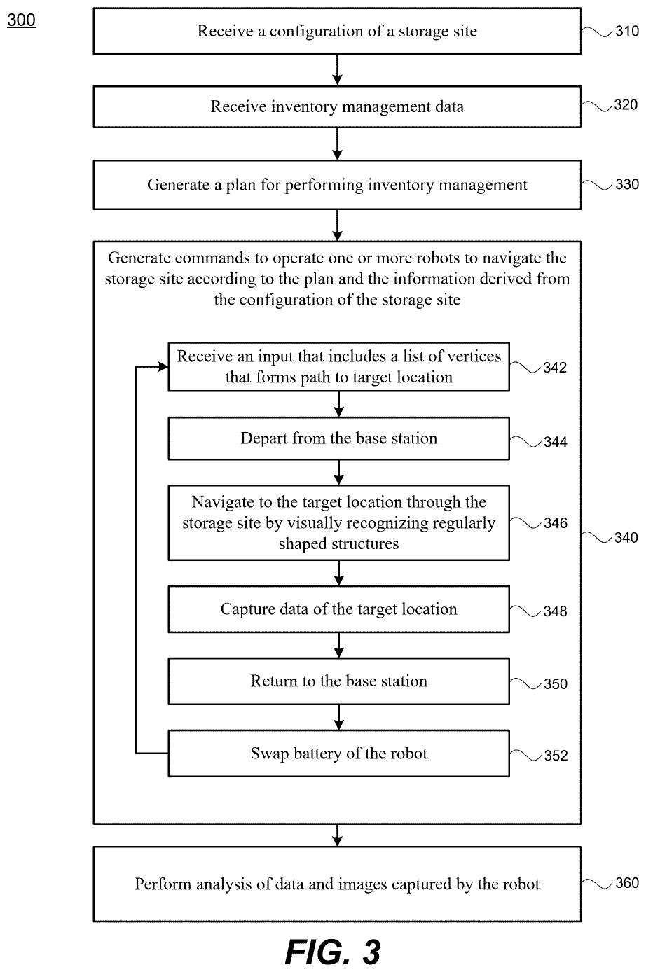

FIG. 3 is a flowchart that depicts an example process for managing the inventory of a storage site, according to an embodiment. The process may be implemented by a computer, which may be a single operation unit in a conventional sense (e.g., a single personal computer) or may be a set of distributed computing devices that cooperate to execute a set of instructions (e.g., a virtual machine, a distributed computing system, cloud computing, etc.). Also, while the computer is described in a singular form, the computer that performs the process in FIG. 3 may include more than one computer that is associated with the computing server 150, the inventory management system 140, the robot 120, the base station 130, or the user device 170.

According to an embodiment, the computer receives 310 a configuration of a storage site 110. The storage site 110 may be a warehouse, a retail store, or another suitable site. The configuration information of the storage site 110 may be uploaded to the robot 120 for the robot to navigate through the storage site 110. The configuration information may include a total number of the regularly shaped structures in the storage site 110 and dimension information of the regularly shaped structures. The configuration information provided may take the form of a computer-aided design (CAD) drawing or another type of file format. The configuration may include the layout of the storage site 110, such as the rack layout and placement of other regularly shaped structures. The layout may be a 2-dimensional layout. The computer extracts the number of sections, aisles, and racks and the number of rows and columns for each rack from the CAD drawing by counting those numbers as appeared in the CAD drawing. The computer may also extract the height and the width of the cells of the racks from the CAD drawing or from another source. In one embodiment, the computer does not need to extract the accurate distances between a given pair of racks, the width of each aisle, or the total length of the racks. Instead, the robot 120 may measure dimensions of aisles, racks, and cells from a depth sensor data or may use a counting method performed by the planner 250 in conjunction with the visual reference engine 240 to navigate through the storage site 110 by counting the number of rows and columns the robot 120 has passed. Hence, in some embodiments, the accurate dimensions of the racks may not be needed.

Some configuration information may also be manually inputted by an administrator of the storage site 110. For example, the administrator may provide the number of sections, the number of aisles and racks in each section, and the size of the cells of the racks. The administrator may also input the number of rows and columns of each rack.

Alternatively, or additionally, the configuration information may also be obtained through a mapping process such as a pre-flight mapping or a mapping process that is conducted as the robot 120 carries out an inventory management task. For example, for a storage site 110 that newly implements the automated management process, an administrator may provide the size of the navigable space of the storage site for one or more mapping robots to count the numbers of sections, aisles, rows and columns of the regularly shaped structures in the storage site 110. Again, in one embodiment, the mapping or the configuration information does not need to measure the accurate distance among racks or other structures in the storage site 110. Instead, a robot 120 may navigate through the storage site 110 with only a rough layout of the storage site 110 by counting the regularly shaped structures along the path in order to identify a target location. The robotic system may gradually perform mapping or estimation of scales of various structures and locations as the robot 120 continues to perform various inventory management tasks.

The computer receives 320 inventory management data for inventory management operations at the storage site 110. Certain inventory management data may be manually inputted by an administrator while other data may be downloaded from the inventory management system 140. The inventory management data may include scheduling and planning for inventory management operations, including the frequency of the operations, time window, etc. For example, the management data may specify that each location of the racks in the storage site 110 is to be scanned every predetermined period (e.g., every day) and the inventory scanning process is to be performed in the evening by the robot 120 after the storage site is closed. The data in the inventory management system 140 may provide the barcodes and labels of items, the correct coordinates of the inventory, information regarding racks and other storage spaces that need to be vacant for incoming inventory, etc. The inventory management data may also include items that need to be retrieved from the storage site 110 (e.g., items on purchase orders that need to be shipped) for each day so that the robot 120 may need to focus on those items.

The computer generates 330 a plan for performing inventory management. For example, the computer may generate an automatic plan that includes various commands to direct the robot 120 to perform various scans. The commands may specify a range of locations that the robot 120 needs to scan or one or more specific locations that the robot 120 needs to go. The computer may estimate the time for each scanning trip and design the plan for each operation interval based on the available time for the robotic inventory management. For example, in certain storage sites 110, robotic inventory management is not performed during the business hours.

The computer generates 340 various commands to operate one or more robots 120 to navigate the storage site 110 according to the plan and the information derived from the configuration of the storage site 110. The robot 120 may navigate the storage site 110 by at least visually recognizing the regularly shaped structures in the storage sites and counting the number of regularly shaped structures. In one embodiment, in addition to the localization techniques such as VIO used, the robot 120 counts the number of racks, the number of rows, and the number of columns that it has passed to determine its current location along a path from a starting location to a target location without knowing the accurate distance and direction that it has traveled.

The scanning of inventory or other inventory management tasks may be performed autonomously by the robot 120. In one embodiment, a scanning task begins at a base station at which the robot 120 receives 342 an input that includes coordinates of target locations in the storage site 110 or a range of target locations. The robot 120 departs 344 from the base station 130. The robot 120 navigates 346 through the storage site 110 by visually recognizing regularly shaped structures. For example, the robot 120 tracks the number of regularly shaped structures that are passed by the robot 120. The robot 120 makes turns and translation movements based on the recognized regularly shaped structures captured by the robot's image sensor 210. Upon reaching the target location, the robot 120 may align itself with a reference point (e.g., the center location) of the target location. At the target location, the robot 120 captures 348 data (e.g., measurements, pictures, etc.) of the target location that may include the inventory item, barcodes, and labels on the boxes of the inventory item. If the initial command before the departure of the robot 120 includes multiple target locations or a range of target locations, the robot 120 continues to the next target locations by moving up, down, or sideways to the next location to continue to scanning operation.

Upon completion of a scanning trip, the robot 120 returns to the base station 130 by counting the number of regularly shaped structures that the robot 120 has passed, in a reversed direction. The robot 120 may potentially recognize the structures that the robot has passed when the robot 120 travels to the target location. Alternatively, the robot 120 may also return to the base station 130 by reversing the path without any count. The base station 130 repowers the robot 120. For example, the base station 130 provides the next commands for the robot 120 and swaps 352 the battery of the robot 120 so that the robot 120 can quickly return to service for another scanning trip. The used batteries may be charged at the base station 130. The base station 130 also may download the data and images captured by the robot 120 and upload the data and images to the data store 160 for further process. Alternatively, the robot 120 may include a wireless communication component to send its data and images to the base station 130 or directly to the network 180.

The computer performs 360 analyses of the data and images captured by the robot 120. For example, the computer may compare the barcodes (including serial numbers) in the images captured by the robot 120 to the data stored in the inventory management system 140 to identify if any items are misplaced or missing in the storage site 110. The computer may also determine other conditions of the inventory. The computer may generate a report to display at the user interface 175 for the administrator to take remedial actions for misplaced or missing inventory. For example, the report may be generated daily for the personnel in the storage site 110 to manually locate and move the misplaced items. Alternatively, or additionally, the computer may generate an automated plan for the robot 120 to move the misplaced inventory. The data and images captured by the robot 120 may also be used to confirm the removal or arrival of inventory items.

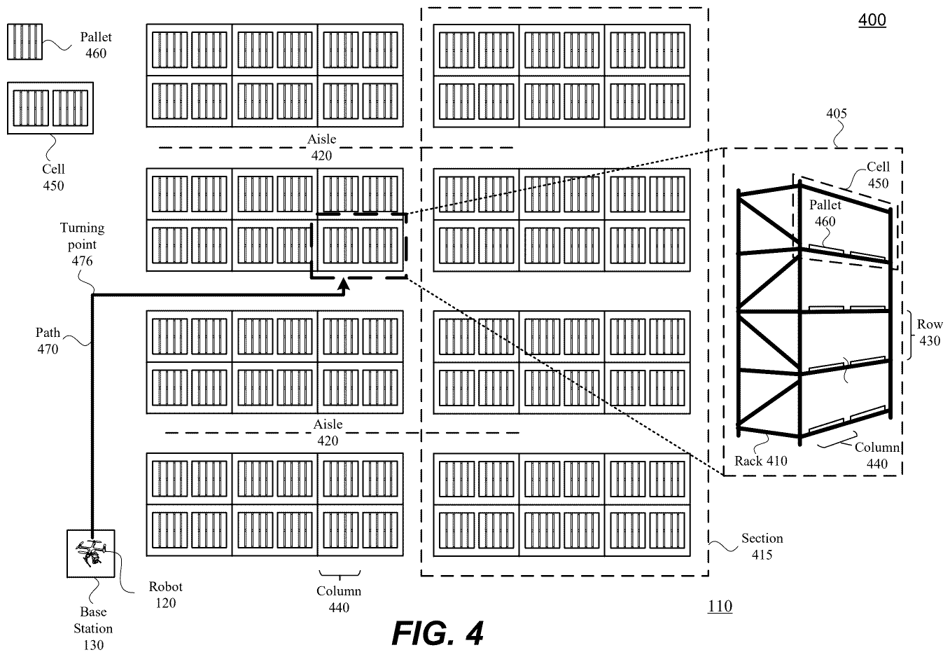

FIG. 4 is a conceptual diagram of an example layout of a storage site 110 that is equipped with a robot 120, according to an embodiment. FIG. 4 shows a two-dimensional layout of storage site 110 with an enlarged view of an example rack that is shown in inset 405. The storage site 110 may be divided into different regions based on the regularly shaped structures. In this example, the regularly shaped structures are racks 410. The storage site 110 may be divided by sections 415, aisles 420, rows 430 and columns 440. For example, a section 415 is a group of racks. Each aisle may have two sides of racks. Each rack 410 may include one or more columns 440 and multiple rows 430. The storage unit of a rack 410 may be referred to as a cell 450. Each cell 450 may carry one or more pallets 460. In this particular example, two pallets 460 are placed on each cell 450. Inventory of the storage site 110 is carried on the pallets 460. The divisions and nomenclature illustrated in FIG. 4 are used as examples only. A storage site 110 in another embodiment may be divided in a different manner.

Each inventory item in the storage site 110 may be located on a pallet 460. The target location (e.g., a pallet location) of the inventory item may be identified using a coordinate system. For example, an item placed on a pallet 460 may have an aisle number (A), a rack number (K), a row number (R), and a column number (C). For example, a pallet location coordinate of [A3, K1, R4, and C5] means that the pallet 460 is located at a rack 410 in the third aisle and the north rack. The location of the pallet 460 in the rack 410 is in the fourth row (counting from the ground) and the fifth column. In some cases, such as the particular layout shown in FIG. 4, an aisle 420 may include racks 410 on both sides. Additional coordinate information may be used to distinguish the racks 410 at the north side and the racks 410 at the south side of an aisle 420. Alternatively, the top and bottom sides of the racks can have different aisle numbers. For a spot check, a robot 120 may be provided with a single coordinate if only one spot is provided or multiple coordinates if more than one spot is provided. For a range scan that checks a range of pallets 460, the robot 120 may be provided with a range of coordinates, such as an aisle number, a rack number, a starting row, a starting column, an ending row, and an ending column. In some embodiments, the coordinate of a pallet location may also be referred in a different manner. For example, in one case, the coordinate system may take the form of “aisle-rack-shelf-position.” The shelf number may correspond to the row number and the position number may correspond to the column number.

### Example Safety Alert Configuration in Inventory Warehouse System

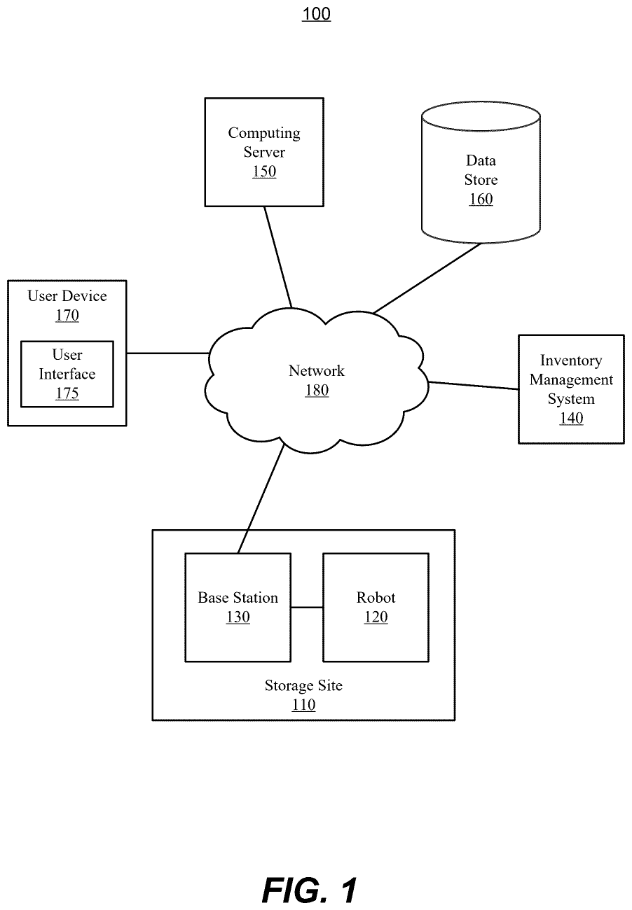

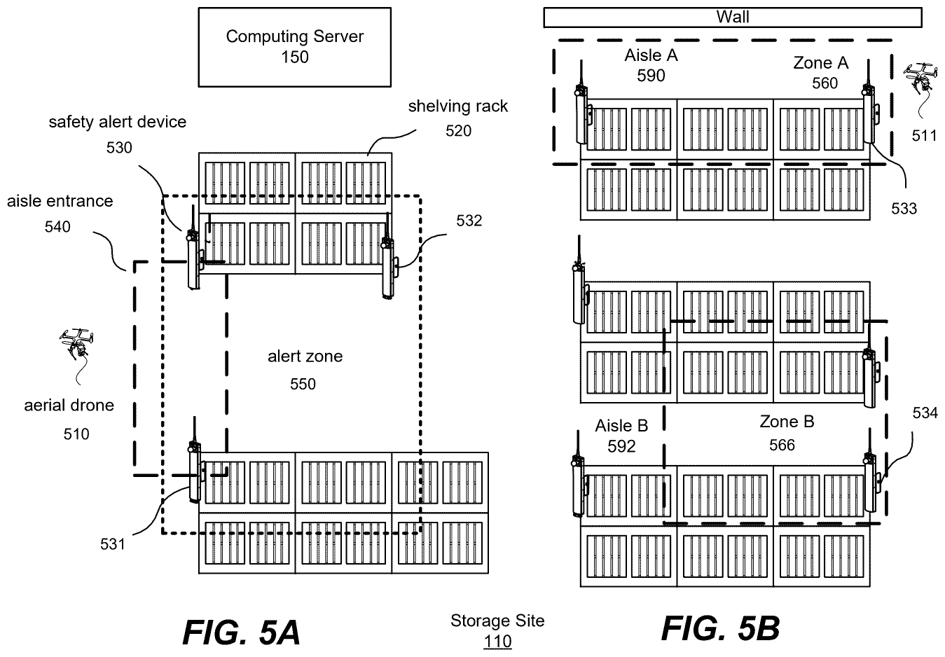

FIG. 5A is a conceptual diagram of an example layout of a storage site 110 that is equipped with an aerial drone, shelving racks, and a network of safety alert devices, in accordance with one or more embodiments. The storage site 110 can be an inventory warehouse but may also be another venue as described in this disclosure. FIG. 5A shows a two-dimensional layout of the storage site 110 with an example of an aerial drone 510 configured to navigate autonomously to perform one or more inventory management tasks. While a single aerial drone 510 is shown in FIG. 5A, in various embodiments there can be more than one aerial drone 510. For example, one or more aerial drones 510 may be deployed to concurrently perform inventory management tasks within the storage site 110. An aerial drone 510 may be an example of robot 120 that is described in FIG. 1 and FIG. 2.

In one or more embodiments, storage site 110 includes a shelving system configured to store items (e.g., inventory items) in a grid system that includes columns and rows. The aerial drone 510 may navigate between row levels of a shelving rack 520 and further perform the inventory management tasks. These management tasks may encompass scanning of barcodes or tags associated with inventory items, detecting misplaced or miscategorized inventory, capturing images or video for visual verification, conducting real-time stock audits, identifying damaged or expired items, monitoring environmental conditions (e.g., temperature, humidity), generating alerts for low-stock or overstock conditions, updating inventory records in coordination with a warehouse management system, or other suitable inventory management tasks.

FIG. 5A illustrates that one or more safety alert devices 530 are installed at specific locations in the storage site 110 to provide warnings to personnel in the storage site 110 on the location of an aerial drone 510. By way of example, at least one subset of the safety alert devices 530 is positioned at specific locations on the shelving rack 520. These locations may align with the entrances of a plurality of aisle entrances 540. For example, each safety alert device 530 in the subset may correspond to a specific aisle. Upon the aerial drone's 510 entry into the aisle entrance 540, the safety alert devices 530 residing within alert zone 550 issue safety indications.

In one or more embodiments, the safety indications issued by the safety alert devices 530 may be provided through visual signals and/or auditory signals. Visual indicators may include flashing LED lights, color-coded signals, or directional light projections to indicate the presence and movement of the aerial drone 510 within a specific aisle. The color or blinking pattern of the lights may change based on factors such as the drone's proximity to personnel, the speed of its movement, or the level of warehouse activity. For example, a steady blue light may indicate the drone's presence in the aisle, while a flashing red light may signal that the drone is approaching a high-traffic area or operating at a lower altitude where personnel movement is detected. Different types of signals (e.g., different colors) may also be issued based on various situations, such as when the aerial drone 510 is operating normally and an incident occurs, etc.

In addition to or alternatively to visual indicators, the safety alert devices 530 may provide auditory warnings, including beeping alarms, spoken alerts, or tonal chimes that vary in frequency or intensity based on the drone's activity. In some embodiments, the alert sound may start at a low volume when the aerial drone 510 enters an aisle and gradually increase if the drone moves closer to personnel. The audio alerts may also be configured to distinguish different drone activities, such as a short beep pattern indicating normal operation and a sustained tone warning of an unexpected movement or potential collision risk.

In some embodiments, the safety alert devices 530 may be equipped with directional sound-emitting components to generate alerts that are localized to the affected area without causing unnecessary disruption throughout the entire storage site 110. In one or more embodiments, the safety alert devices 530 may coordinate with each other to create an alert sequence, guiding personnel's attention toward the drone's movement path through a series of sequentially activated lights or sounds.

In some variations, the safety alert devices 530 may be adaptive, adjusting the alert intensity or duration based on real-time warehouse conditions, such as background noise levels or the presence of multiple drones operating simultaneously. Additionally, the safety alert devices 530 may be configured to deactivate or modify alerts when no personnel are detected in the vicinity, thereby reducing unnecessary alarm activation while maintaining safety protocols.

FIG. 5B is a conceptual diagram of an example layout of a zone in an inventory warehouse that is equipped with an aerial drone and shelving racks, in accordance with one or more embodiments. As shown in FIG. 5B, the storage site 110 may be partitioned into one or more zones, where zone implies a particular section within the storage site 110 with potential to be designated as an alert zone. In one or more embodiments, each zone includes an aisle entrance 540, where at least one safety alert device 530 is installed. Zone A 560 or may include at least one column of shelving racks 520, whereas zone B 566 may comprise both sides of columns of shelving racks 520. In another embodiment, these zones can be modified, added and deleted by the computing server 150.

In one embodiment, a plurality of safety alert devices 530 may issue safety alerts simultaneously. For example, returning to FIG. 5A, the safety alert devices 530, 531, 532 within the alert zone 550 may initiate multiple safety indications at the same time when the aerial drone 510 navigates within the aisle.

In another embodiment, the safety alert devices 530 may issue safety indications that are distinct from one another. The disparity in safety indications may vary in terms of alert type, alert signal, urgency or other relevant factors, depending on the nature and severity of the warehouse issue. The alert type could correspond to the category of the issue that initiates the safety indications. These categories, for example, may be the state of the inventory management task of the aerial drone 510 (e.g. initiation or termination) or the navigational altitude of the aerial drone 510 within the aisle. The alert sounds, for example, warnings may involve visual or auditory indication, for example, entering of the aerial drone into an aisle may trigger fast-paced, high pitch alert with pulsating red light, and at the same time, the exiting of the aerial drone from the aisle may trigger slow-paced low pitch alert with yellow strobe lighting. This may ensure different types of safety risks within the storage site 110 be communicated and pertain to timely alerts of the particular issue at the specific location.

In some embodiments, a storage site 110 may include a series of safety alert devices 530 that are arranged in series and correspond to a series of entrances of inventory aisles in the storage site 110. These safety alert devices 530 may be positioned in various topologies, including a linear arrangement along the aisles, a grid-based arrangement distributed throughout the warehouse, or a zone-based clustering where certain safety alert devices 530 cover designated sections of the storage site 110. The arrangement of the safety alert device(s) 530 may be determined based on factors such as warehouse layout, traffic patterns of personnel, and the typical flight paths of the aerial drone 510.

For example, in one possible topology, the safety alert devices 530 may be positioned at regular intervals along each aisle, forming a linear configuration where each device covers a specific section of the aisle. This configuration allows for localized safety indications that activate sequentially as the aerial drone 510 moves through the aisle. Another possible topology involves a centralized hub of safety alert devices 530 that communicate with distributed units positioned throughout the warehouse. In this arrangement, a primary safety alert device 530 near a main entrance or control station may act as a coordinator, receiving drone location data and triggering appropriate alerts across the network of devices.

In some embodiments, a hierarchical topology may be implemented, where safety alert devices 530 are grouped into clusters. The alert patterns may be dynamically adjusted based on real-time warehouse conditions. The safety alert devices 530 may coordinate with one another to ensure continuous and seamless tracking of the aerial drone 510. As the aerial drone 510 moves from one section of the warehouse to another, the alert devices 530 in the vicinity may activate in a synchronized manner to provide personnel with real-time location awareness. For example, when the aerial drone 510 enters a new aisle, the corresponding safety alert devices 530 at the entrance and along the aisle may activate visual and auditory warnings. As the drone progresses further into the aisle, devices at the previous location may deactivate, while those ahead of the drone may activate in anticipation of its movement.

In some embodiments, when the aerial drone 510 moves from a first aisle to a second aisle, a first safety alert device 530 positioned at the entrance of the first aisle may deactivate, indicating that the drone has exited that section. At the same time, a second safety alert device 530 at the entrance of the second aisle may activate, providing an updated safety indication of the drone's current position. This handoff between safety alert devices 530 allows for a dynamic and efficient alert system that accurately reflects the movement of the aerial drone 510 throughout the storage site 110. In some embodiments, the transition between alerts may be further refined by incorporating predictive algorithms that anticipate the drone's path and preemptively activate or deactivate safety indications based on expected movement patterns.

In some embodiments, multiple aerial drones 510 are operating concurrently within the storage site 110. The safety alert devices 530 may coordinate to provide distinct and adaptive safety indications that reflect the movement of each drone. The coordination among safety alert devices 530 may involve multi-drone tracking, differentiated signaling, and intelligent alert prioritization to ensure personnel are aware of the presence and movement of multiple drones.

In some embodiments, the safety alert devices 530 may track and distinguish between multiple aerial drones 510 by assigning each drone a unique identifier. Each aerial drone 510 may communicate its location and movement data to a central control system or directly to the network of safety alert devices 530. The safety alert devices 530 may then adjust the signals based on the number of drones present in a particular zone, their relative proximity to personnel, and the level of activity in the warehouse. For example, if two aerial drones 510 are navigating within the same aisle but at different elevations, the safety alert devices 530 may use different colored visual indicators to represent each drone's position (e.g., blue for Drone A and green for Drone B). Alternatively, or additionally, distinct auditory tones or patterns may be used to differentiate the aerial drones 510, allowing personnel to recognize the presence of multiple aerial drones 510 without confusion.

In some embodiments, the safety alert devices 530 coordinate to prioritize alerts when multiple drones are detected in overlapping areas. If two or more drones are moving toward the same aisle or are expected to cross paths within a zone, the safety alert devices 530 may issue an escalated alert (e.g., increased blinking frequency or higher-pitched warning tones) to draw immediate attention to the increased activity. The system may also include predictive coordination, where safety alert devices 530 anticipate potential drone intersections and activate preemptive alerts to notify personnel before the drones enter a high-risk zone.

To manage dynamic drone activity efficiently, the safety alert devices 530 may also implement an adaptive alerting mechanism that adjusts the intensity or coverage of the alerts based on the real-time distribution of drones across the warehouse. For instance, if multiple drones are operating in separate zones, the safety alert devices 530 in each respective zone may function independently to provide localized alerts. However, if aerial drones 510 begin to converge into the same zone, the safety alert devices 530 may synchronize the alerts to ensure seamless and comprehensive safety indications. This synchronization may involve a cascading activation pattern, where the alert intensity gradually increases as more drones enter a shared space, ensuring personnel receive clear and progressive warnings.

In some embodiments, multiple aerial drones 510 are performing coordinated tasks—such as inventory scanning along parallel aisles or simultaneous stock verification across different warehouse sections—the safety alert device(s) 530 may establish zone-based coordination. For example, the safety alert devices 530 within each zone communicate with one another to regulate the activation of alerts based on drone movement patterns. For example, if two drones are working in adjacent aisles but are unlikely to cross paths, the safety alert devices 530 may activate localized alerts for each aisle.

### Example Safety Alert Communication in Inventory Warehouse System

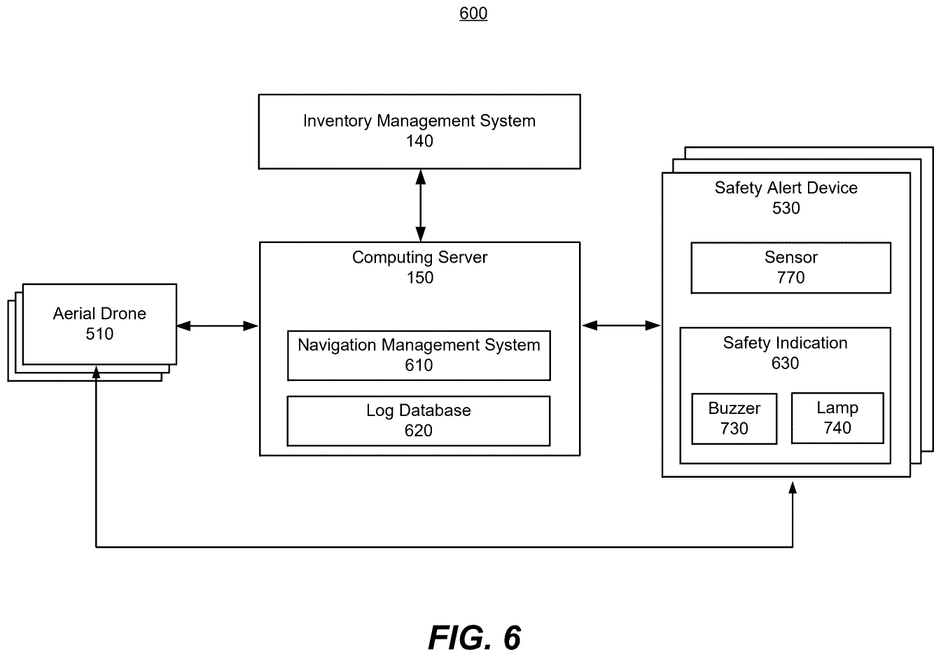

FIG. 6 is a block diagram illustrating components of an example safety indications communication system for an aerial drone 510, in accordance with one or more embodiments. As shown in FIG. 6, within the communication network 600, the aerial drone 510 communicates with both the computing server 150 and safety alert device 530. The computing server 150 may maintain software application for users to manage the storage site 110, navigation management system 610 and log database 620.

The location of an aerial drone 510 may be communicated or detected by one or more safety alert devices 530 through any suitable ways. In one or more embodiments, as the aerial drone 510 navigates through an aisle of the storage site 110, the computing server 150 detects the location of the aerial drone 510 via communication. The communication includes the aerial drone 510 transmitting a notification to trigger at least one safety indication component (e.g. buzzer 730, lamp 740) of the safety alert devices 530 to activate. In some embodiments, the safety alert devices 530 are installed with sensors 770 to directly detect the location of the aerial drone 510. In response to detecting the aerial drone 510 in the aisle, the safety alert device 530 installed at an entrance of the aisle issues a safety indication 630.

In some embodiments, the aerial drone 510 transmits its location data in real time to the computing server 150 using wireless communication protocols such as Wi-Fi, Bluetooth, Zigbee, or a proprietary mesh network. The computing server 150 then determines which safety alert device(s) 530 should be activated based on the drone's position and sends corresponding activation commands to the appropriate safety alert device(s) 530. This communication-based detection method ensures precise tracking of the aerial drone 510 and allows for coordinated activation of safety indications.

In some embodiments, the safety alert devices 530 are equipped with motion sensors, proximity sensors, or infrared (IR) sensors that directly detect the movement of the aerial drone 510. These sensors may be installed at various points within the storage site 110, including the entrances of aisles, along shelving racks 520, or at strategic overhead positions. When a aerial drone 510 enters a monitored area, the sensor-equipped safety alert devices 530 can autonomously trigger visual or auditory alerts to notify personnel in the vicinity.

In some embodiments, the safety alert devices 530 may use computer vision or LiDAR-based detection methods. In some embodiments, safety alert devices 530 equipped with cameras may analyze the video feed in real time to recognize the presence of the aerial drone 510 based on its shape, size, or movement pattern. This approach allows for high-accuracy detection without requiring direct communication from the drone. Similarly, LiDAR-based safety alert device(s) 530 may generate a 3D map of the warehouse environment and detect the aerial drone 510 based on its reflective signature, enabling real-time spatial awareness of drone activity.

In some embodiments, the aerial drone 510 may carry an active RFID tag or beacon that continuously emits signals received by RFID readers or beacon sensors integrated into the safety alert devices 530. As the drone moves through the storage site 110, different safety alert devices 530 pick up the signal and determine the drone's location based on signal strength or triangulation techniques. In some embodiments, the safety alert devices 530 may employ ultrasonic or radio frequency (RF) triangulation to determine the aerial drone's location. In an RF-based system, multiple safety alert devices 530 positioned throughout the warehouse may receive the drone's transmitted signals and calculate its position using time-of-flight measurements or signal strength analysis. Similarly, in an ultrasonic detection system, ultrasonic sensors placed at known reference points may detect sound pulses emitted by the aerial drone 510, allowing for precise location tracking based on the time delay between transmission and reception.

In some embodiments, the safety alert devices 530 may integrate multiple detection methods for enhanced accuracy and redundancy. For instance, a combination of infrared sensors, RFID readers, and RF triangulation may be used to ensure reliable detection even in environments where one method alone may be obstructed (e.g., due to shelving racks or warehouse obstacles). Additionally, or alternatively, sensor fusion techniques may be applied, where data from multiple sources—such as communication-based tracking, motion detection, and LiDAR mapping—are combined to improve the overall precision of drone localization.

In one or more embodiments, the aerial drone is further configured to receive data from navigation management system 610. The received data may be an indication of issues occurred within the storage site 110 which affects the current operation of the aerial drone 510 or a topological information from one or more safety alert devices 530. The aerial drone 510 adjusts its navigation path according to the received data. For example, returning to FIG. 5B, when the safety alert device 533 from zone A 560 issues a safety indication and the aerial drone 511 receives instructions from the computing server 150 to adjust the navigational operation, the aerial drone 511 may change its route to using Aisle B 592 instead of entering the Aisle A 590 as previously instructed.

The computing server 150 is configured to store a log of aerial drone 510 activities in the log database 620. This log includes operational data such as the navigation duration, navigation path history, communication history such as control inputs, and any remote commands issued during the flight, battery status and locations. The log database 620 maintains record of locations where the aerial drone 510 was present, each entry timestamped with possible further analysis and performance optimization.

FIG. 7 is an isolated view of a safety alert device, in accordance with one or more embodiments. As shown in FIG. 7, at least one of the safety alert devices 530 includes a battery holder 710, a hanger 720, a buzzer 730 and a lamp 740. The safety alert device 530 may further include other components, for example a wi-fi antenna 750, a CPU board 760 and a sensor 770. The battery holder 710 is a component to mount a battery to power supply that may be fixed on a pilar of a shelving rack 520. The hanger 720 is a component to adjust a vertical level of the safety alert device to the shelving rack pilar. In one or more embodiment, the hanger comprises one or more apertures, that aligns with a set of receiving apertures of a shelving rack pilar to attach the safety alert device 530 to the corresponding shelving rack.

In one or more embodiments, the buzzer 730 is an electronic component that produces an alert sound signal through various mechanism, such as electromechanical or piezoelectric principles. Such acoustic device includes speakers, which can produce a wider range of sounds and frequencies for application requiring voice or complex audio signal and siren. The buzzer 730 allows adjustment of the alert sound level and deactivation of the alert sound through a manual operation.

In one or more embodiments, the lamp 740 is an electronic device that generates a alert light signal for specific conditions or event via a vertically oriented display. The alert light may be an LED or similar energy-efficient light which produces light in one or more colors to communicate and notify the status of the aerial drone 510 to nearby objects. In some embodiments, the warning light may be a human readable sign (e.g. “do not enter”) on the bottom of the aisle entrance 540 to provide clarity to human, indicating a specific restriction related to the corresponding aisle entrance 540. The lamp 740 allows adjustment of the lighting level and deactivation of the sound through a manual operation.

In some embodiments, for both the buzzer 730 and the lamp 74, the manual operation for may include a physical button press, a dial or rotary switch that can be turned to a specific position, a toggle switch that can be flipped to a certain position (e.g. “OFF”) which cuts the power to the sound generating component, and a voice command.

The wi-fi antenna 750 is a component to transmit and receive wireless signals for communications between corresponding devices. Furthermore, the safety alert device 530 includes a central processing unit (CPU) board which may process incoming data (e.g. instructions for navigation), to manage communication between the computing server 150 and the aerial drone 510, and to control overall functionality of the safety alert device 530, such as the operation between the buzzer 730 and the lamp 740 in conjunction with object detection by the data generated by the sensor 770. In one or more embodiments, the sensor 770 is a component to detect one or more objects. The type for the sensor 770 may be a time of flight (ToF) sensor using distance measurement metrics, an ultrasonic sensor, a laser sensor such as light detection and ranging (LIDAR) using laser beams, or camera-based vision sensors using cameras combined with algorithms to identify and locate objects.

In some embodiments, safety alert devices 530 may utilize wireless communication protocols, such as Bluetooth, Wi-Fi, or a proprietary mesh network, to share real-time drone location data and coordinate alert activations. In some embodiments, the safety alert devices 530 may be integrated with the warehouse management system to align alert triggers with operational events, such as scheduled drone inventory scans or high-traffic periods when personnel presence is increased. Through intelligent coordination and adaptive activation of safety indications, the safety alert devices 530 provide a robust safety mechanism that enhances situational awareness and reduces collision risks between aerial drones and warehouse personnel.

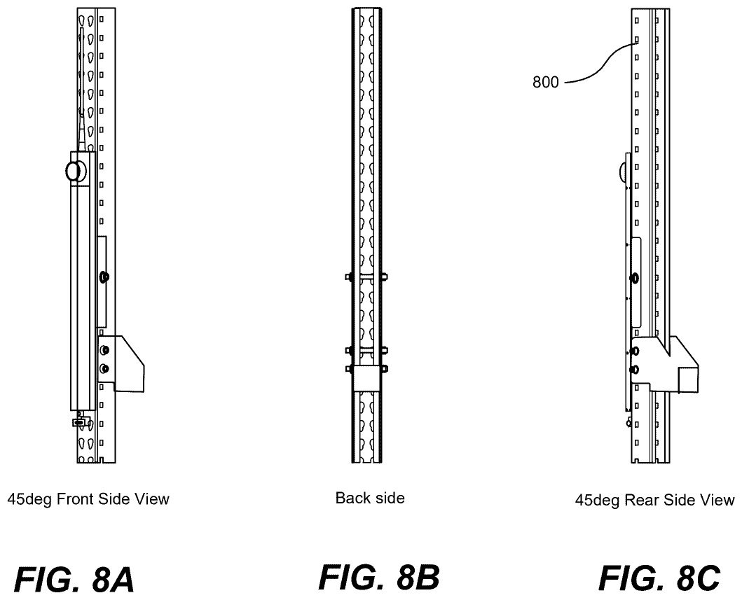

FIGS. 8A, 8B, and 8C illustrate different angle views of a safety alert device attached to a pilar, in accordance with one or more embodiments. In one embodiment, the safety alert device 530 may be attached to the shelving rack pilar 800 using mechanical fasteners, such as bolts, screws or similar hardware. As shown in FIG. 8, the shelving rack pilar 800 features one or more series of apertures, or openings that correspond to the mounting points of the safety alert device 530. FIG. 8A illustrates a 45-degree front side view, FIG. 8B a back side view, and FIG. 8C a 45-degree rear side view of the safety alert device 530 attached on the shelving rack pilar 800 using the hanger 720. In one embodiment, the battery holder 710 may be attached to the shelving rack pilar 700.

In some embodiments, the height of the safety alert device 530 may easily be adjusted by modifying mounting points 810 on the shelving rack pilar 800. As shown in FIG. 8, the safety alert device 530 is equipped with relocation flexibility to various heights on the shelving rack pilar 800, firmly securing the attachment using a set of nut and bolt 820. Likewise, the battery holder 710 may also be mounted to the rear of the shelving rack 800 using same mechanism, (e.g., one or more sets of nuts and bolts 830), offering adjustable positioning. The battery holder 710 is complementary to the rack to allow easy installation.

The safety alert device 530 includes a battery holder to store a battery for power source, a hanger with a plurality of apertures that are complementary to a set of receiving apertures of the shelving rack 520 to adjust the safety alert device 530 vertically. A buzzer and a lamp of the safety alert device 530 is configured to generate one or more safety indications in various forms, such as alert sound and alert light. The buzzer allows adjustments of alert sound level and deactivation of the alert sound through a manual operation. The lamp is further configured to include a vertically oriented display that emits a dynamic light pattern in frequency in accordance with a distance between the aerial drone 510 and to the aisle entrance 540. The lamp allows adjustment of the alert light level and deactivation of the alert light through a manual operation.

In some embodiments, the safety alert device 530 can be elongated as the length about the same as the height of the rack and may include a series of indication lights. As the aerial drone 510 enters the aisle, the indication lights may be activated by different sections of the display corresponding to the vertical level of the aerial drone 510. In one embodiment, each section of the display may indicate alert in different colors according to the alert type.

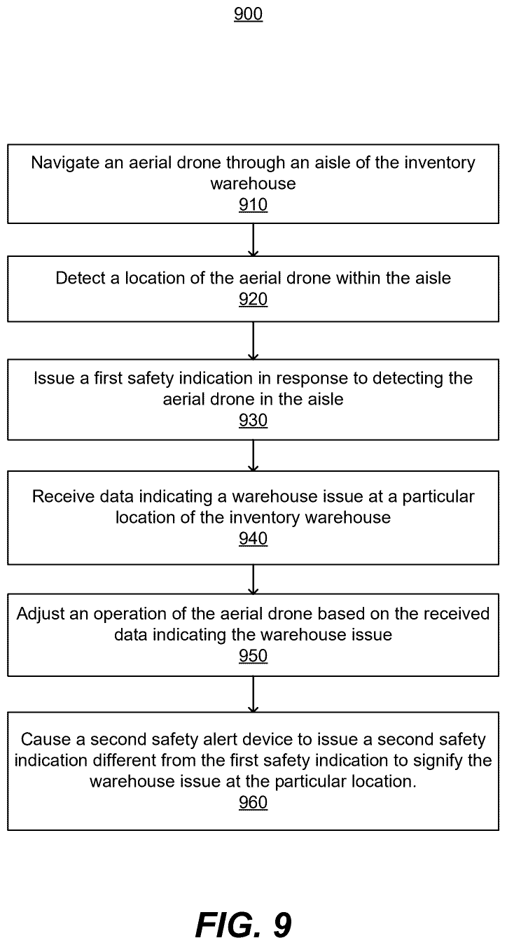

FIG. 9 is a flowchart for a method for inventory management in an inventory warehouse, in accordance with one or more embodiments. The aerial drone 510 navigates 910 through an aisle of the storage site 110. In some embodiments, the inventory items are stored in plurality of sets of shelving racks 520. The shelving racks may be in a grid system that includes columns and rows. As the aerial drone 510 traverses along the aisle and between one or more row levels of a shelving rack, the aerial drone 510 may further scan inventory labels on inventory items for inventory management purposes. Inventory labels may take various forms, such as barcodes, RFID tags, QR codes, alphanumeric identifiers, or other machine-readable markings.

The computing server 150 may determine 920 the location of the aerial drone 510 within the aisle via communication network. In one or more embodiments, the communication includes data communications such as transmitting notification to trigger the safety indication (e.g., alert sound, alert light, etc.) on the safety alert device(s) 530. For example, as the aerial drone 510 arrives at the entrance of an aisle to perform inventory management task within the storage site 110, the aerial drone 510 transmits the current location (e.g., map coordinates, localization information, etc.) to the computing server 150. The computing server 150 generates an instruction (e.g., turn on the red alert light in low frequency level of the device(s) in zone A and turn on high pitch alert sound of the device(s) in zone A, etc.) to trigger the safety indication and transmits the instruction to one or more of the safety alert devices 530 via communication network.

In some embodiments, instead of or in addition to the aerial drone 510 communicating its location information, the sensor of the safety alert device 530 may directly detect the location of the aerial drone 510. For example, as the aerial drone 510 enters the aisle entrance 540, the sensor 770 of the safety alert device 530 located on the aisle entrance may detect the presence of the aerial drone 510. The safety alert device 530 transmits the location data of the aerial drone 510 to the computing server 150, and request instruction for safety indication. Depending on the system configurations, the safety alert device 530 may trigger the indication as soon as it detects the aerial drone 510.

In one embodiment, the computing server 150 may store, in the log database 620, a log of aerial drone 510 activities, timestamp, duration of navigation, communication history between devices, etc. During the navigation, the aerial drone 510 collects log data through its onboard sensors and stores the log data in its onboard storage (e.g., an SD card, flash memory, etc.). The aerial drone 510 transmits the log data to the log database 620 within the computing server 150 via communication network depending on the availability of the infrastructure. In another embodiment, the transmitted location data may be stored in log database 620 and be utilized by the navigation management system 610 for further use. (e.g., navigation planning, etc.)

In response to determining that the aerial drone 510 is in an aisle, one of the safety alert device(s) 530 installed at an aisle entrance issues 930 a first safety indication. The first safety indication, such as a yellow blinking frequency with beeping sound, is triggered by the first safety alert device. The first safety alert device may refer to, temporarily referring to FIG. 5B, one of the safety alert devices, such as the safety alert device 533 installed at the entrance of Aisle A 590 in the Zone A 560. In one embodiment, the storage site 110 may be divided into one or more zones, and the safety alert device 530 may issue safety indications that are zone-particular in response to the aerial drone 510 entering the aisle of that particular zone (e.g., Zone B 566). A zone may correspond to a section of an aisle, a group of neighboring aisles, a specific area within the storage site 110 for inventory item storage, or a region with particular environmental conditions (e.g., safety restrictions, temperature configurations, etc.).

The aerial drone 510 receives 940 data from the computing server 150 indicating the storage site 110 issue at a different location. Depending on the configuration of the environment, the storage site 110 issue may be identified by detecting system software malfunctions, sensor readings, or automated monitoring systems. In one embodiment, the image sensor of a different aerial drone within the storage site 110, other than the aerial drone 510 (which is performing an inventory management task), may capture an image data (e.g., photographs, video feeds, infrared images, etc.) of particular location of the storage site 110, and transmit the image data to the computing server 150. The computing system server 150 may communicate with the inventory management system 140 to further identify the issues of the storage site 110 based on the image data and generate an instruction to adjust the operation of the aerial drone 510, currently operating a task.

The aerial drone 510 adjusts 950 its operation in response to receiving the data from the computing server 150. The data from the computing server 150 may be a modified operation instruction to perform another inventory task at a different zone (e.g., Zone B 566). For example, returning to FIG. 5B again, the aerial drone 510 scanning the inventory items in Zone A 560 may receive warehouse issue data from the computing server 150 that Zone B 566 needs an immediate inventory availability check. Upon receiving the data, the aerial drone 510 may change its navigation to Zone B 566 towards the Aisle B 592, to adjust its operation. In one embodiment, the first safety indication of the safety alert device 533, may be removed once the aerial drone 510 leaves the current aisle, Aisle A 590 in the zone A 560.

A second safety alert device causes 960 a second safety indication to signify the storage site 110 issue at the different location. Returning to FIG. 5B, the second safety alert device may refer to the safety alert device 534 (different from that of the first safety alert device 533) installed at the entrance of Aisle B 592 in the Zone B 566. For example, as the aerial drone 510 enters the Aisle B 592 in the Zone B 566, the safety alert device 534 triggers the steady blue light with high pitch alarm, different from that of the first safety indication.

What is claimed is:

1. A system comprising:
an aerial drone configured to navigate autonomously in an inventory warehouse to perform one or more inventory management tasks; and
a plurality of safety alert devices, at least one of the safety alert devices installed at an entrance of an aisle of the inventory warehouse, wherein the at least one of the safety alert devices is configured to:
responsive to the aerial drone being in the aisle, issue a safety indication signifying that the aerial drone is located in the aisle.

2. The system of claim 1, wherein the inventory warehouse is a shelving system configured to store one or more items in a grid system that includes columns and rows.

3. The system of claim 1, wherein the aerial drone is further configured to scan inventory labels on inventory items.

4. The system of claim 3, wherein the inventory labels is one or more of a barcode, an RFID tag, a QR code, an alphanumeric identifier, or other machine-readable markings.

5. The system of claim 1, wherein the aerial drone is further configured to navigate between one or more row levels of a shelving rack.

6. The system of claim 1, wherein the at least one of the safety alert devices comprises:
a battery holder configured to store a battery for powering the safety alert device;
a hanger configured to adjust to a vertical level relative to a rack pillar;
a buzzer configured to generate an alert sound; and
a lamp configured to generate an alert light in conjunction with the buzzer, wherein the alert sound and the alert light form the indication.

7. The system of claim 6, wherein the hanger comprises a plurality of apertures that are complementary to a set of receiving apertures of the rack pillar to attach the safety alert device to the rack pillar.

8. The system of claim 6, wherein the buzzer is further configured to:
allow adjustment of an alert sound level; and
allow deactivation of the alert sound through a manual operation.

9. The system of claim 6, wherein the lamp is further configured to:
include a vertically oriented display;
include a dynamic light pattern in frequency in accordance with a distance between the aerial drone to the aisle entrance;
allow adjustment of an alert light level; and
allow deactivation of the alert light through a manual operation.

10. The system of claim 1, wherein at least a subset of the safety alert devices is installed at rack locations that correspond to entrances of a plurality of aisles, each safety alert device in the subset corresponds to an aisle.

11. The system of claim 1, wherein the inventory warehouse is divided into one or more zones and the safety alert device is configured to issue a zone-particular safety indication responsive to the aerial drone entering a particular zone of the inventory warehouse.

12. The system of claim 1, wherein the safety indication is an alert light that is installed at the entrance of the aisle.

13. The system of claim 1, wherein the safety indication is an alert sound that is installed at the entrance of the aisle.

14. The system of claim 1, wherein the at least one of the safety alert devices is further configured to:
remove the safety indication responsive to detecting that the aerial drone has left the aisle.

15. The system of claim 1, further comprising a communication network enabling the aerial drone and a one or more safety alert devices to communicate, wherein the communication includes the drone transmitting a notification to trigger the indication on the one or more safety alert devices.

16. The system of claim 1, further comprising a server configured to store a log of aerial drone activities, wherein the log includes timestamp, duration of navigation, communication history, and one or more aisle locations of where the aerial drone were present.

17. A safety alert device, comprising:
memory storing executable instructions; and
one or more processors, wherein the executable instructions, when executed by the one or more processors, cause the one or more processors to:
issue a safety indication from a safety alert device, signifying that a presence of an aerial drone in an aisle of an inventory warehouse, wherein the aerial drone is configured to navigate autonomously within the inventory warehouse to perform one or more inventory management tasks; and
wherein the safety alert device is part of a plurality of safety alert devices, installed at an entrance of an aisle of the inventory warehouse.

18. The safety alert device of claim 17, wherein issuing the safety indication from the safety alert device:
include a vertically oriented display;
include an output of audio signal;
include a dynamic light pattern in frequency in accordance with a distance between the aerial drone to the aisle entrance;
include a dynamic volume in level in accordance with a server determined setting;
allow deactivation of an alert sound through manual operation; and
allow deactivation of an alert light through manual operation.

19. A method for inventory management in an inventory warehouse comprising:
navigating an aerial drone through an aisle of the inventory warehouse;
detecting a location of the aerial drone within the aisle;
issuing a first safety indication in response to detecting the aerial drone in the aisle, wherein the first safety indication is issued by a first safety alert device installed at an entrance of the aisle;
receiving data from a computing system indicating a warehouse issue at a particular location of the inventory warehouse;
adjusting an operation of the aerial drone based on the received data from the computing system indicating the warehouse issue; and
causing a second safety alert device to issue a second safety indication to signify the warehouse issue at the particular location, the second safety alert device located at the particular location.

20. The method of claim 19, further comprising:
capturing, by the aerial drone, an image data during navigating the inventory warehouse;
transmitting the image data to the computing system;
identifying one or more of inventory warehouse issue of the aisle based on the image data; and
generating an instruction to adjust the operation of the aerial drone.
